(19) United States
(12) Patent Application Publication
(10) Pub. No.: US 2011/0132731 A1
(43) Pub. Date: Jun. 9, 2011

(54) STEERING WHEEL SWITCH ASSEMBLY

(75) Inventors: Cynthia Bowman, Grosse Pointe Woods, MI (US); Norbert L. Weinert, Troy, MI (US); Greg Kelly, Royal Oak, MI (US); John Maranzano, Shelby Township, MI (US)

(73) Assignee: NISSAN TECHNICAL CENTER NORTH AMERICA, INC., Farmington Hills, MI (US)

(21) Appl. No.: 12/633,128

(22) Filed: Dec. 8, 2009

(51) Int. Cl. H01H 9/00

(52) U.S. Cl. 200/61.54

(57) ABSTRACT

Embodiments of steering wheels with switches for sunroofs or convertible tops and vehicles having the same are disclosed herein. One embodiment disclosed herein is of a steering wheel assembly for a vehicle having a sunroof located in an aperture of a roof of the vehicle having a panel movable with respect to the roof to open and close the aperture. The assembly comprises a steering wheel disposed in the vehicle and a sunroof switch disposed on the steering wheel and electrically connectible to the sunroof to move the sunroof panel.

### FIELD OF THE INVENTION

The present invention relates to a switch for operating a sunroof/moon-roof of a vehicle or a convertible top. In particular, the present invention relates to locating such a switch on the steering wheel.

### BACKGROUND

Presently, sunroofs are operated by a switch located within the passenger compartment of the vehicle. Generally, the sunroof switch is positioned proximal to the sunroof, typically between the front end of the sunroof and the windshield, on a portion of the interior trim. The location requires a driver to remove his or her hand from the steering wheel to operate the switch. In addition, the driver must reach up to find the switch, typically requiring that the driver take his or her eyes off the road to locate the switch. Locating the switch on the interior trim proximate the sunroof also exposes the switch to the elements when the sunroof is open.

### SUMMARY

Embodiments of steering wheels with switches for sunroofs or convertible tops are disclosed herein. One embodiment disclosed herein is of a steering wheel assembly for a vehicle having a sunroof located in an aperture of a roof of the vehicle having a panel movable with respect to the roof to open and close the aperture. The assembly comprises a steering wheel disposed in the vehicle and a sunroof switch disposed on the steering wheel and electrically connectible to the sunroof to move the sunroof panel.

Also discloses here are embodiments of a vehicle comprising a roof having an aperture, a sunroof positioned within the aperture and having a panel movable with respect to the roof to open and close the aperture, a steering wheel disposed within the vehicle and a sunroof switch disposed on the steering wheel configured to move the panel.

### BRIEF DESCRIPTION OF THE DRAWINGS

FIG. 1 is a perspective view of a vehicle having a sunroof steering wheel switch;

FIG. 2 is a perspective view of a vehicle interior showing a sunroof and a sunroof switch mounted on the steering wheel;

FIG. 3 is a plan view of the steering wheel showing the cruise control switch on the right side of the steering wheel and the sunroof switch on the left side of the steering wheel;

FIG. 4 is an enlarged view of the sunroof switch and trim panel;

FIG. 5 is a section view taken along a vertical plane running through the sunroof switch, showing the switch pivot and electrical contacts for up and down movement of the switch; and

FIG. 6 is a basic electrical diagram showing the steering wheel switch connections to the vehicle electrical power and sunroof.

### DETAILED DESCRIPTION

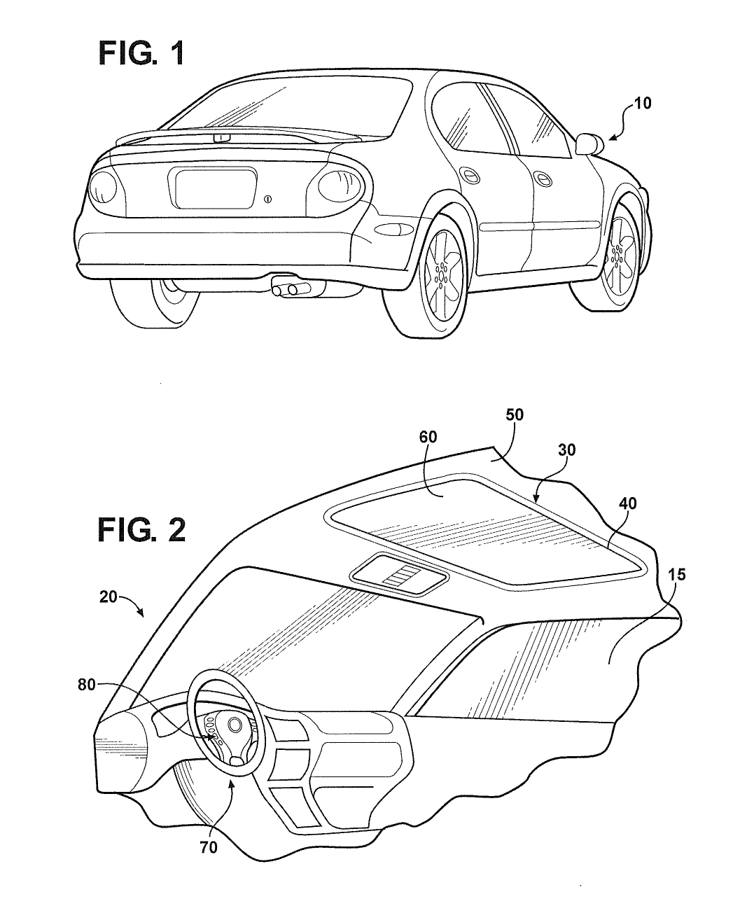

FIG. 1 is a perspective view of a vehicle 10 having a steering wheel with a sunroof switch. The vehicle shown is used by way of example and is not meant to be limiting. The vehicle can be of any type that has a sun roof or convertible top. As used herein, it is to be understood that the term “sunroof” also contemplates convertible tops, such that that “sunroof switch” includes switches to raise and lower convertible tops.

Positioning the sunroof switch on the steering wheel allows the driver to operate the sunroof without taking his/her hands off of the steering wheel. The steering wheel switch location is more ergonomic as the driver does not need to reach overhead to operate the switch. Locating the switch on the steering wheel assembly of the vehicle passenger compartment is more aesthetically pleasing and efficient as an independent switch is not required on the sunroof. In addition, locating the switch on the steering wheel distances the switch from the movable sunroof panel, thereby reducing the chance that water or other contaminants entering through the sunroof will affect the sunroof switch.

Locating the sunroof switch on the steering wheel also allows for the steering wheel manufacturer to incorporate the switch and/or switch assembly prior to supplying to the automobile manufacturer.

FIG. 2 is a perspective view of a vehicle interior or passenger compartment 15 having a steering wheel assembly 20 as disclosed herein. The vehicle has a sunroof 30 located in an aperture 40 of a roof 50 of the vehicle 10 having a panel 60 movable with respect to the roof 50 to open and close the aperture 40. The steering wheel assembly 20 can comprise a steering wheel 70 disposed in the passenger compartment 15 of the vehicle 10. A sunroof switch 80 is disposed on the steering wheel 70 and is electrically connected to the sunroof 30 to move the sunroof panel 60.

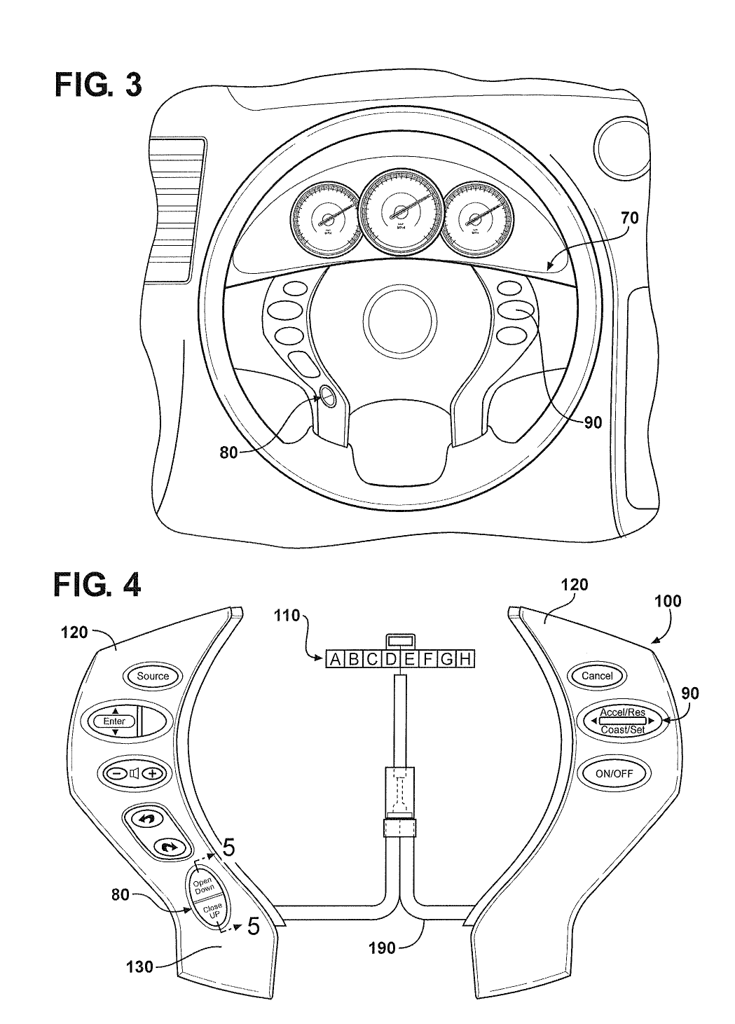

FIG. 3 is a plan view of the steering wheel 70 showing the locations of the sunroof switch 80 and the cruise control switch 90. As seen in FIG. 3, the cruise control switch 90 is located on the right side of the steering wheel 70 and the sunroof switch 80 is located on the left side of the steering wheel 70. These locations are provided by way of example and are not meant to be limiting. The locations can be reversed, with the cruise control switch 90 on the left side of the steering wheel 70 and the sunroof switch 80 on the right side of the steering wheel 70 as desired or required. In addition, the horizontal and vertical positioning of the sunroof switch 80 on the particular side is arbitrary and is shown in FIG. 3 as a non-limiting example. The switch can be positioned to optimize accessibility as desired or required. The sunroof switch can have an outer surface that can be substantially flush with adjacent outer surfaces of the steering wheel.

The steering wheel 70 can include a hub 100, as shown in FIG. 4. FIG. 4 is an enlarged view of the steering wheel hub 100. The hub 100 can comprise a central portion 110 and trim 120 at least partially surrounding the central portion 110. As illustrated in FIG. 4, the trim 120 can be positioned on either side of the central portion 110. The sunroof switch 80 can be disposed in the trim 120.

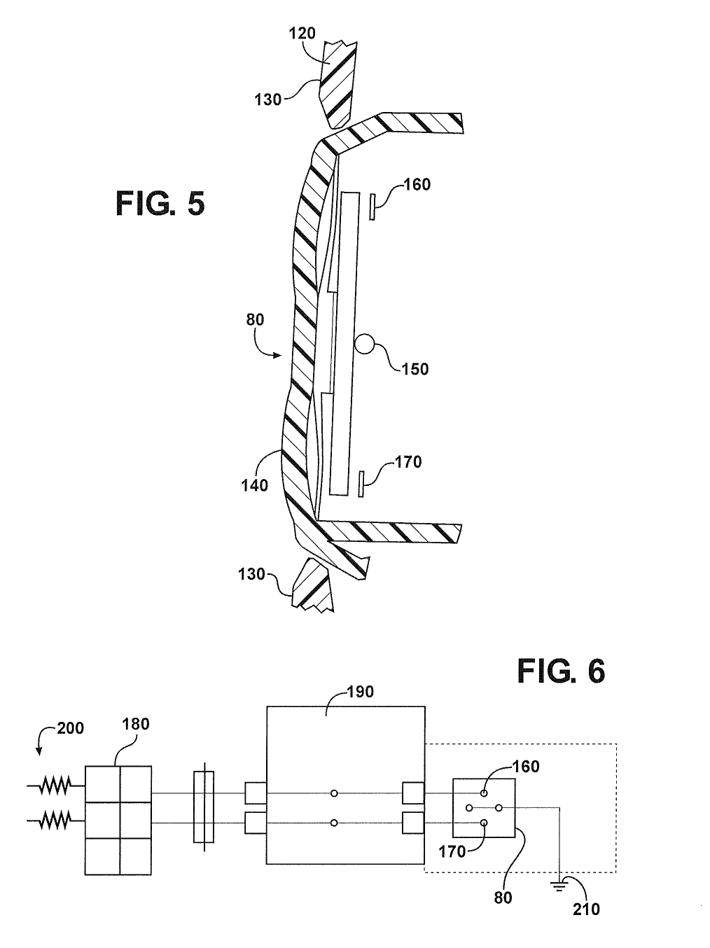

The trim 120 can comprise an outer surface 130, as shown in FIG. 5, which is a cross sectional view of the sunroof switch 80 and trim 120. The sunroof switch 80 can comprise an outer surface 140. The outer surface 140 of the sunroof switch 80 can be substantially flush with the outer surface 130 of the trim 120.

The sunroof switch 80 can be a toggle type switch having a pivot 150 with contacts 160, 170 on each side of the pivot 150 for opening and closing the panel 60. The outer surface 140 in the area of the pivot 150 can be flush with the adjacent outside surface 130 of the trim 120. The outside surface of the switch in the area of the contacts 160, 170 may be slightly raised. The toggle type switch is provided by way of example and is not meant to be limiting. Other switch types can be used as desired or required, for example a push button or slide switch. Furthermore, the switch, whether a toggle type or other type, can be substantially flat with the entire surface substantially flush with the surrounding steering wheel or trim outer surface 130.

The switch assembly 20 can further comprise a motor 180 and a wire harness 190. The motor 180 is operable to move the panel 60. The wire harness 190 electrically connects the switch 80 to the motor 180 as shown in FIG. 6. The wire harness 190 is shown in FIG. 4. The wire harness 190 can include a clock spring (not shown) disposed proximal to the steering wheel 70 and configured to allow rotational movement of the steering wheel 70 while maintaining connection to the motor 180. Other connections known by those skilled in the art can be used as desired or required.

An example of the operation of the sunroof is described by means of example and not limitation. A pair of guide rails can be provided on the vehicle roof, respectively arranged on both sides in a width direction of the vehicle. Guide pins are supported in the guide rails in such a manner that the guide pins are slidable in a vehicle longitudinal direction. The guide pins are each connected to an interior face of the panel. The motor is connected to the guide pins by means of cables, for example. When the motor is driven by the sunroof switch, a rotation of an output shaft of the motor occurs in one direction or the other direction. The rotation of the output shaft of the motor moves the guide pins along the respective guide rails. The panel connected to the guide pins performs a sliding operation in which the panel moves between a full-closed position and a slide-open position. The panel of the sunroof can also be operated by the sunroof switch to tilt, wherein the panel moves between the full-closed position and a tilt-up position.

FIG. 6 is a simple circuit diagram illustrating the operation of the sunroof with the switch. The sunroof switch 80 has, for example, two contacts 160, 170. When the switch 80 is operated in a first direction, the switch 80 connects the power source 200 of the motor 180 to ground 210. If the sunroof is in the initial closed position, engaging contact 160 via the switch 80 will open the sunroof. Engaging contact 170 via the switch 80 will tilt the sunroof. Breaking engagement with contact 160 with the sunroof open will close the sunroof. Breaking engagement with contact 170 when the sunroof is tilted will close the sunroof. This operation of the sunroof is provided by way of example and is not meant to be limiting. Other electrical configurations can be used as desired or required by those skilled in the art.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A steering wheel assembly for a vehicle having a sunroof located in an aperture of a vehicle roof having a panel movable with respect to the roof to open and close the aperture, the assembly comprising:
a steering wheel disposed in the vehicle; and
a sunroof switch disposed on the steering wheel, the sunroof switch electrically connectible to the sunroof to move the sunroof panel.

2. The steering wheel assembly of claim 1, wherein the steering wheel includes a hub, and wherein the sunroof switch is disposed on the hub.

3. The steering wheel assembly of claim 2, wherein the hub comprises a central portion and trim partially surrounding the central portion, and wherein the sunroof switch is disposed in the trim.

4. The steering wheel assembly of claim 3, wherein the trim comprises an outer surface and the sunroof switch comprises an outer surface, and wherein the outer surface of the sunroof switch is substantially flush with the outer surface of the trim.

5. The steering wheel assembly of claim 2, wherein the steering wheel comprises cruise controls mounted on one side of the hub, and wherein the sunroof switch is positioned on an opposite side of the hub from the cruise controls.

6. The steering wheel assembly of claim 1, wherein the sunroof switch is a toggle type switch having a pivot with contacts on each side of the pivot for opening and closing the panel.

7. The steering wheel assembly of claim 6, wherein the sunroof switch has an outer surface, and wherein the outer surface of the pivot is substantially flush with adjacent outer surfaces of the steering wheel.

8. The steering wheel assembly of claim 1 further comprising a wire harness and a motor operable to move the panel, the wire harness electrically connecting the switch to the motor.

9. The steering wheel assembly of claim 8, wherein the wire harness includes a clock spring disposed proximal to the steering wheel and configured to allow rotational movement of the steering wheel while maintaining connection to the motor.

10. A vehicle comprising:
a roof having an aperture;
a sunroof positioned within the aperture and having a panel movable with respect to the roof to open and close the aperture;
a steering wheel disposed within the vehicle; and
a sunroof switch disposed on the steering wheel configured to move the panel.

11. The vehicle of claim 10, wherein the steering wheel includes a hub, and wherein the sunroof switch is disposed on the hub.

12. The vehicle of claim 11, wherein the hub comprises a central portion and trim partially surrounding the central portion, and wherein the sunroof switch is disposed in the trim.

13. The vehicle of claim 12, wherein the trim comprises an outer surface and the sunroom switch comprises an outer surface, and wherein the outer surface of the sunroof switch is substantially flush with the outer surface of the trim.

14. The vehicle of claim 11, wherein the steering wheel comprises cruise controls mounted on one side of the hub, and wherein the sunroof switch is positioned on an opposite side of the hub from the cruise controls.

15. The vehicle of claim 10, wherein the sunroof switch is a toggle type switch having a pivot with contacts on each side of the pivot for opening and closing the panel.

16. The vehicle of claim 15, wherein the sunroof switch has an outer surface, and wherein the outer surface of the pivot is substantially flush with adjacent outer surfaces of the steering wheel.

17. The vehicle of claim 10 further comprising a motor operable to move the panel, the motor electrically connected to the switch via a wire harness.

18. The vehicle of claim 17, wherein the wire harness includes a clock spring disposed proximal to the steering wheel and configured to allow rotational movement of the steering wheel while maintaining connection to the motor.
